(19) United States
(12) Patent Application Publication
(10) Pub. No.: US 2010/0079376 A1
(43) Pub. Date: Apr. 1, 2010

(54) INERTIAL MOUSE DEVICE AND ACCELERATION-CALIBRATING METHOD THEREOF

(75) Inventor: Ruey-Der Lou, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: IMU SOLUTIONS, INC., Hsinchu (TW)

(21) Appl. No.: 12/571,599

(22) Filed: Oct. 1, 2009

(30) Foreign Application Priority Data
Oct. 1, 2008 (TW) 097137768

(51) Int. Cl. G09G 5/08

(52) U.S. Cl. 345/166

(57) ABSTRACT

An inertial mouse device includes a main body; an accelerometer unit disposed in the main body for performing a motion-sensing function of the main body with at least two degrees of freedom, and generating a calibration output value when the main body is in a still state; and a microprocessor in communication with the accelerometer unit, receiving and processing the calibration output value with an operation so as to obtain an angle of the accelerometer unit relative to horizon. The microprocessor generates a shift signal when the main body is in a motional state, and performs calibration for the shift signal according to the angle.

### FIELD OF THE INVENTION

The present invention relates to an inertial mouse, and more particularly to an inertial mouse capable of performing operations for calibration dynamically. The present invention also relates to a calibrating method of an inertial mouse, and more particular to an acceleration-calibrating method of the inertial mouse.

### BACKGROUND OF THE INVENTION

A mouse device or a cursor control device is a common control device or operational interface for manipulating a computer system. Conventional mouse devices are mainly classified into two types according to their operational principles, i.e. mechanical mouse devices and optical mouse devices. A mechanical mouse device controls cursor movement on a display of the computer system by detecting the movement of the ball on a supporting plane. On the other hand, an optical mouse device controls cursor movement on a display of the computer system by detecting the light reflection from a supporting plane.

Nowadays, with the rapid development of microelectromechanical systems (MEMS) and semiconductor techniques, a new type of mouse device, which is so-called as an inertial mouse, is designed. An inertial mouse device basically controls cursor movement on a display of the computer system by detecting motion acceleration of the mouse device. A microprocessor and at least two accelerometers are disposed in the mouse device. While moving on a supporting plane, the two accelerometers detect motion accelerations of the mouse device in two perpendicular axes on the supporting plane. The resulting signals are inputted into the microprocessor for determining corresponding shifts. Then the cursor moves on the display of the computer system according to the determined shifts. Since an accelerometer can be produced with a very small size, they can be integrated into a circuit board inside the mouse device. Furthermore, the bi-axial sensing degrees of freedom may be implemented with a single bi-axial sensing unit or two uni-axial sensing units.

Principally, a conventional inertial mouse device detects linear shifts of the mouse device on the supporting plane instead of moving paths. The detection means, however, does not reflect the actual control manner of the mouse device by the user. Generally, a user manipulates a mouse device with his wrist or elbow as a pivot. It means rotational motion in addition to linear motion is generally involved. The resulting centrifugal force, however, is neglected from determination of motion acceleration in current designs. As a result, the cursor movement cannot be well performed as expected. The deviation effect is particularly significant for rapid and/or long motion of the mouse device.

Furthermore, in the design of an accelerometer the sensing degrees of freedom for detecting motion accelerations of the mouse device, e.g. in two perpendicular directions on the supporting plane, are made to be substantially parallel to the bottom face of the mouse device. Alternatively, the accelerometer may be disposed on the circuit board of the mouse device so that the sensing axes are substantially parallel to the bottom face of the mouse device. Accordingly, the sensing axes are also parallel to the supporting plane when the mouse device is placed on the supporting plane. In other words, as long as the supporting plane is horizontal, the sensing axes are horizontally perpendicular to each other. However, if the supporting plane is not horizontal and there is a non-zero angle θ existent between the supporting plane and horizon, a component of acceleration g·sinθ, where g is the acceleration of gravity, will be involved. The component of acceleration, once mixed up with the motion accelerations of the mouse device on the supporting plane, will adversely affect the precision of the cursor control.

### SUMMARY OF THE INVENTION

Therefore, an object of the present invention is to provide a calibrating method of an inertial mouse device for offsetting the component of gravity acceleration.

Another object of the present invention is to provide a calibrating method of an inertial mouse device for offsetting the component of centrifugal acceleration.

A further object of the present invention is to provide an inertial mouse device with a dynamically calibrating function.

According to an aspect of the present invention, a calibrating method of an inertial mouse device includes: discriminating whether the inertial mouse device is in a still state; calculating a tilting angle θ of the inertial mouse device relative to horizon according to an output of an accelerometer of the inertial mouse device when the inertial mouse device is in the still state; calculating an acceleration according to the output of an accelerometer of the inertial mouse device and the titling angle θ when the inertial mouse device is in a motional state; and subtracting a value of g·sinθ, where g is gravity acceleration, from the calculated acceleration, thereby obtaining a calibrated acceleration.

According to another aspect of the present invention, a calibrating method of an inertial mouse device includes:

discriminating whether the inertial mouse device is in a still state; calculating tilting angles θₓ and θ_{y} of the inertial mouse device relative to horizon in perpendicular X-axis and Y-axis according to outputs of an accelerometer unit which performs a motion-sensing function of the inertial mouse device with two degrees of freedom when the inertial mouse device is in the still state; calculating accelerations aₓ and a_{y} in an X-axis direction and a Y-axis direction according to the outputs of the accelerometer unit and the tilting angles θₓ and θ_{y}; and subtracting values of g·sinθₓ and g·sinθ_{y}, where g is gravity acceleration, from the calculated accelerations aₓ and a_{y}, respectively, thereby obtaining calibrated accelerations in the X-axis direction and the Y-axis direction.

According to a further aspect of the present invention, an inertial mouse device includes a main body; an accelerometer unit disposed in the main body for performing a motion-sensing function of the main body with at least two degrees of freedom, and generating a calibration output value when the main body is in a still state; and a microprocessor in communication with the accelerometer unit, receiving and processing the calibration output value with an operation so as to obtain an angle of the accelerometer unit relative to horizon, generating a shift signal when the main body is in a motional state, and performing calibration for the shift signal according to the angle.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic diagram illustrating the appearance of an inertial mouse device according to an embodiment of the present invention;

FIG. 1B is a functional block diagram of an inertial mouse device according to an embodiment of the present invention;

FIG. 2 is a schematic diagram illustrating the tilting of a supporting plane where the inertial mouse device is operated; and

FIG. 3A and FIG. 3B are flowcharts combined to illustrate a calibrating method of an inertial mouse device according to an embodiment of the present invention.

### DETAILED DESCRIPTION OF THE PREFERRED EMBODIMENT

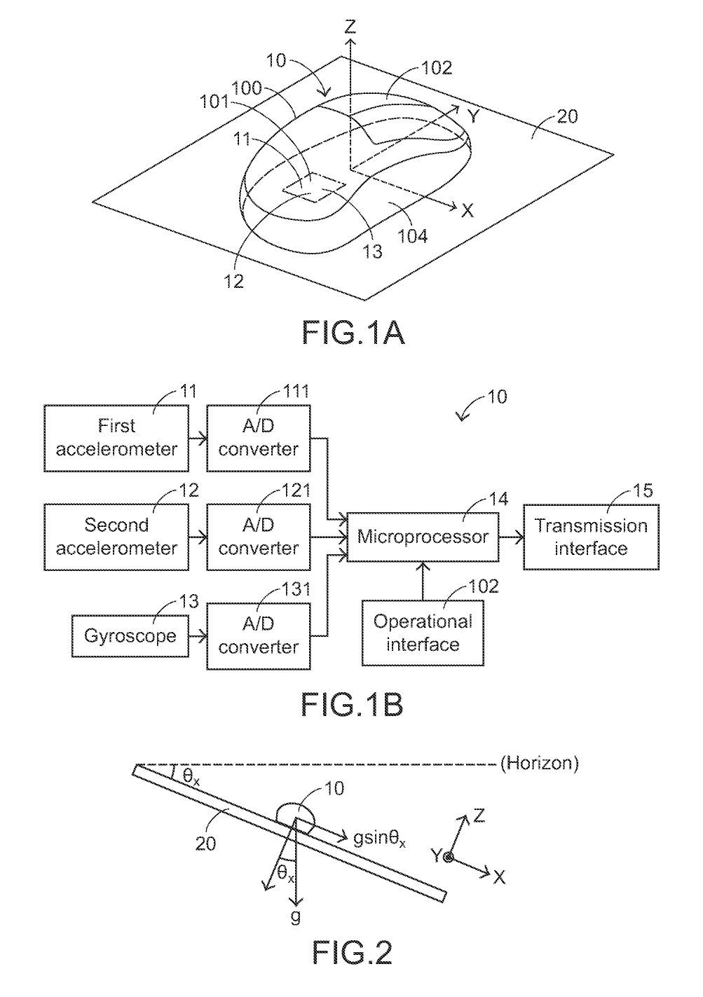

Please refer to FIG. 1A and FIG. 1B which schematically illustrate an inertial mouse device according to an embodiment of the present invention. The inertial mouse device 10 mainly includes a main body 100 in which an operational interface member 102 is disposed. The operational interface member 102 includes parts manipulated by the user for enabling designated functions of the system that the mouse device is working with. The inertial mouse device 10 further includes a first accelerometer 11, a second accelerometer 12, a gyroscope 13, a microprocessor 14 and a transmission interface 15. In an embodiment, the first accelerometer 11 and second accelerometer 12 detect motion accelerations of the mouse device in two perpendicular axes directions, e.g. an X-axis direction and a Y-axis direction as shown in FIG. 1A, on the supporting plane 20. The X-axis and Y-axis are both parallel to a bottom face 104 of the mouse device 10 and perpendicular to a Z-axis which represents an axis penetrating top and bottom of the mouse device, and represent an axis penetrating front and rear and an axis penetrating left and right of the mouse device, respectively. The bottom face 104 is substantially parallel to the supporting plane 20 where the mouse device 10 is rested, and thus the X-axis and Y-axis are also parallel to the supporting plane 20. On the other hand, the gyroscope 13 detects an angular motion associated with the Z-axis, which will be described in more detail later.

Signals generated in response to the detections are then outputted to the microprocessor 14 electrically connected to the first and second accelerometers 11 and 12 and the gyroscope 13. If the signals are analog signals such as voltage signals, it is preferred that analog-to-digital converters 111, 121 and 131 are provided for converting the signals into a digital form to be processed by the microprocessor 14. The microprocessor 14 is also electrically connected to the operational interface member 102. In response to the signals received from the accelerometers, gyroscope and/or operational interface member, the microprocessor 14 outputs a signal to a computer system (not shown) via the transmission interface 15 for cursor control or execution of designated functions.

The operational interface member 102, for example, may include click switches and a scroll-bar control roller. In FIG. 1A, only left and right click switches are exemplified for illustration of the operational interface member 102. The transmission interface 15 may but does not necessarily communicate with the computer system in a wireless manner.

The above-mentioned units 11˜15 may be but are not necessarily mounted on a circuit board 101 which is disposed inside the main body 100 and parallel to the bottom surface 104.

On a condition that the supporting plane 20 is substantially horizontal, the first accelerometer 11 and the second accelerometer 12 detect the motion accelerations in the X-axis direction and the Y-axis direction and generate the first acceleration aₓ and the second acceleration a_{y}, respectively, defined as the follows:

aₓ=(Vₓ−V_{Ox})/V_{Sx} (1),

and

a_{y}=(V_{y}−V_{Oy})/V_{Sy} (2),

wherein Vₓ denotes a first voltage value outputted by the first accelerometer 11; V_{Ox} denotes a first voltage offset or bias for the first accelerometer 11; V_{Sx} denotes a first conversion coefficient, e.g. a first voltage sensitivity for the first accelerometer 11; V_{y} denotes a first voltage value outputted by the second accelerometer 12; V_{Oy} denotes a second voltage offset or bias for the second accelerometer 12; and V_{Sy} denotes a second conversion coefficient, e.g. a second voltage sensitivity for the second accelerometer 12.

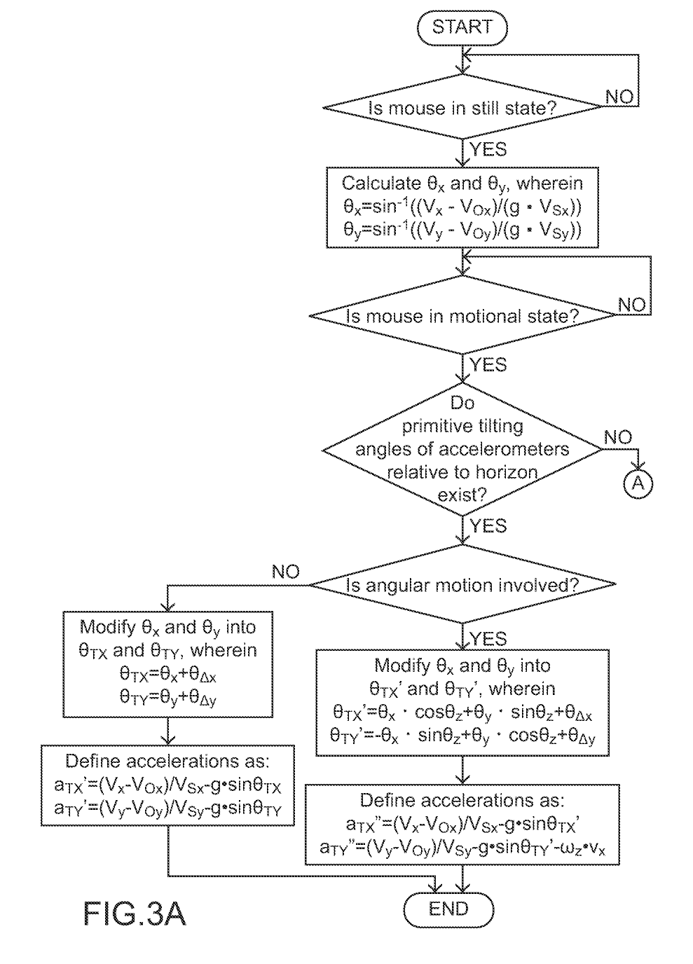

On the other hand, on a condition that the supporting plane 20 is not horizontal, as illustrated in FIG. 2, the inertial mouse according to the present invention performs calibration for the detection signals in order to remove the component of acceleration resulting from the slanting plane 20. As shown, the supporting plane 20 tilts from horizon at an angle θₓ in X-axis and at an angle θ_{y} in Y-axis. Accordingly, once the mouse device 10 is rested on the supporting plane 20, the first accelerometer 11 is inherently imparted thereto a component of acceleration of g·sinθₓ and the second accelerometer 12 is inherently imparted thereto a component of acceleration of g·sinθ_{y}, where g is gravity acceleration. Under this circumstance, the first accelerometer 11 and the second accelerometer 12 detect the motion accelerations in the X-axis direction and the Y-axis direction and generate the first acceleration aₓ and the second acceleration a_{y} with deviations. Therefore, actual motion accelerations aₓ′ and a_{y}′ is redefined as the follows:

aₓ′=(Vₓ−V_{Ox})/V_{Sx}−g·sinθₓ (3),

and

a_{y}′=(V_{y}−V_{Oy})/V_{Sy}−g·sinθ_{y} (4).

With the subtraction of g·sinθₓ and g·sinθ_{y} from primarily determined accelerations aₓ and a_{y}, the components of gravity acceleration resulting from the slanting supporting plane are removed so as to realize actual motion accelerations aₓ′ and a_{y}′.

As for the tilting angle θₓ in X-axis and the tilting angle θ_{y} in Y-axis, they can be estimated by the microprocessor 14 when the mouse device 10 is in a still state or moved at a constant velocity on the slanting supporting plane 20, i.e. aₓ′=0 and a_{y}′=0. Generally, it is hard to keep moving the mouse device at a constant velocity. Therefore, the angles are basically determined in a still state of the mouse device 10 on the supporting plane 20 in the following discussion. Since aₓ′ and a_{y}′ are both zero, the following formulae are derived from the formulae (3) and (4):

θₓ=sin⁻¹((Vₓ−V_{Ox})/(g·V_{Sx})) (5),

and

θ_{y}=sin⁻¹((V_{y}−V_{Oy})/(g·V_{Sy})) (6).

In an embodiment of the present invention, the determination of the still state of the mouse device is performed by sampling outputs of the accelerometers 11 and 12 at intervals, e.g. every 10 microseconds, and seeing how the outputs change with time. For example, if the accelerometers 11 and 12 output zero or constant voltages in a predetermined number of continuous sampling cycles, e.g. 10 cycles tₙ₋₁₀˜tₙ₋₁, it is determined that the mouse device is possibly still at the current time tₙ. However, in practice, the outputs would not be exactly constant and might slightly fluctuate due to, for example, noise. As such, as long as each of the outputs in each axis lies within a specified range or the deviation from a statistical average of the 10 cycles is less than a threshold, the outputs are considered to be constant.

For reconfirmation, velocities realized by integrating the accelerations aₓ and a_{y} with time in last sampling cycle tₙ₋₁ are further referred to. It is determined that the mouse device is still at the current time tₙ if the velocities vₓ and v_{y} are both less than a threshold. In contrast, for the velocities vₓ and v_{y} both greater than the threshold, it is determined that the mouse device is moved with acceleration at the current time tₙ.

On the other hand, if one of the velocities vₓ and v_{y} is less than the threshold and the other is greater than the threshold, the present invention provides a further discriminating criterion for reconfirming whether the mouse device 10 is still on the supporting plane 20 or not. In an embodiment, the further discriminating step is performed by monitoring the voltage outputs in a much longer term than the primary discriminating step described above. For example, in the further discriminating step, previous 100 sampled voltage outputs are referred to. The determination of the still state of the mouse device in the further discriminating step is similar to that in the primary discriminating step described above. That is, as long as each of the sampled voltage outputs in each axis lies within a specified range or the deviation from a statistical average of the 100 cycles is less than a threshold, it is determined that the mouse device is still. The threshold used herein may be the same as or different from the threshold used in the primary discriminating step. The thresholds are preset and recorded in a memory device accessible by the microprocessor 14.

In brief, the angle θₓ in X-axis and the angle θ_{y} in Y-axis are first estimated by the microprocessor 14 based on the formulae (5) and (6) when the mouse device 10 is in a still state or moved at a constant velocity on the slanting supporting plane 20. Afterwards, whenever the mouse device is moved, the actual motion accelerations aₓ′ and a_{y}′ are calculated based on the formulae (3) and (4) introduced thereinto the angles θₓ and θ_{y}. After the actual motion accelerations aₓ′ and a_{y}′ are realized, cursor control are performed by integrating the accelerations aₓ′ and a_{y}′ with time to realize motion velocities vₓ′ and v_{y}′, and integrating the motion velocities vₓ′ and v_{y}′ with time to realize corresponding shifts in the X-axis and Y-axis directions. The microprocessor 14 then processes the shifts in the X-axis and Y-axis directions into a shift signal which is transmitted to the computer system for locating the destination of the cursor.

In this way, the destination of the cursor can be relatively precisely located compared to prior art since the undesired component of gravity acceleration is offset.

In addition to the tilting of the supporting plane, the precision of cursor control is also affected by user's operating manners. For example, there might be a pivotal motion about Z-axis while the user is moving the mouse device with his elbow or wrist as a pivot. The pivotal motion, since introducing a centrifugal force, adds an undesirable acceleration to the motion acceleration in the Y-axis direction. The centrifugal force generated when the mouse device has an angular velocity about Z-axis makes the motion acceleration in the Y-axis direction imparted with an additional acceleration associated with the X-axis direction, i.e. ω_{z}·vₓ, where ω_{z} is the angular velocity and vₓ is the velocity of the mouse device in the X-axis direction. Therefore, the component of centrifugal acceleration resulting from the pivotal motion of the mouse device about Z-axis needs to be offset. Furthermore, the tilting angles θₓ and θ_{y} are introduced thereinto a component of rotation angle θ_{z} about Z-axis and required to be calibrated into values θₓ′ and θ_{y}′.

Accordingly, the actual motion accelerations aₓ″ and a_{y}″ in the X-axis and Y-axis directions, respectively, are redefined as:

aₓ″=(Vₓ−V_{Ox})/V_{Sx}−g·sinθₓ′ (7),

and

a_{y}″=(V_{y}−V_{Oy})/V_{Sy}−g·sinθ_{y}′−ω_{z}·vₓ (8),

wherein the determination of the parameters θₓ′, θ_{y}′, ω_{z} and vₓ will be described hereinafter.

The gyroscope 13 mentioned above with reference to FIG. 1A and FIG. 1B is used for determining the angular velocity ω_{z}. When the mouse device 10 has an angular motion about Z-axis, the gyroscope 13 detects the angular motion and outputs a voltage output V_{z} to the microprocessor 14 accordingly. The microprocessor 14 then processes the voltage output V_{z} into the angular velocity ω_{z} based on the following formula:

ω_{z}=(V_{z}−V_{Oz})/V_{Sz} (9),

wherein V_{z} denotes a voltage value outputted by the gyroscope 13; V_{Oz} denotes a third voltage offset or bias in measuring Z-axis rotation; and V_{Sz} denotes a third conversion coefficient, e.g. a third voltage sensitivity for the gyroscope 13.

The calibrated tilting angles θₓ′ and θ_{y}′ are defined as the following:

θₓ′=θₓ·cosθ_{z}+θ_{y}·sinθ_{z} (10),

and

θ_{y}′=−θₓsinθ_{z}+θ_{y}·cosθ_{z} (11),

wherein the rotation angle θ_{z} about Z-axis is determined by integrating the angular velocity ω_{z} with time.

The velocity vₓ in the X-axis direction can be determined by integrating the acceleration aₓ with time, as previously described.

Likewise, after the actual motion accelerations aₓ″ and a_{y}″ are realized, cursor control are performed by integrating the accelerations aₓ″ and a_{y}″ with time to realize motion velocities vₓ″ and v_{y}″, and integrating the motion velocities vₓ″ and v_{y}″ with time to realize corresponding shifts in the X-axis and Y-axis directions. The microprocessor 14 then processes the shifts in the X-axis and Y-axis directions into a shift signal which is transmitted to the computer system for locating the destination of the cursor.

In this way, the destination of the cursor can be more precisely located compared to prior art since both the undesired component of gravity acceleration and the undesired component of centrifugal acceleration are offset.

It is to be noted that in the above embodiments, it is assumed that the first and second accelerometers 11 and 12 are disposed in and parallel to the circuit board 101 which is further parallel to the bottom surface 104. In practice, however, the first and second accelerometers 11 and 12 are hard to be perfectly parallel to the circuit board 101 and the circuit board is hard to be perfectly parallel to the bottom surface 104. Under this circumstance, the tilting angles should be further calibrated and the calibrated angles θ_{TX} and θ_{TY} relative to the horizon in X-axis and Y-axis, respectively, are redefined as follows:

θ_{TX}=θₓ+θ_{Δx} (12),

and

θ_{TY}=θ_{y}+θ_{Δy} (13),

wherein θ_{Δx} and θ_{Δy} are primitive tilting angles of the first and second accelerometers 11 and 12 relative to the circuit board 101 plus primitive tilting angles of the circuit board 101 relative to the bottom surface 104. The angles θ_{Δx} and θ_{Δy} are previously measured and recorded in a memory accessible by the microprocessor 14.

In other words, the angles θₓ and θ_{y} in the formulae (3) and (4) are replaced with the calibrated angles θ_{TX} and θ_{TY} to realize motion accelerations a_{TX}′ and a_{TY}′.

Furthermore, with the rotation angle θ_{z} about Z-axis taken into account, the calibrated angles θ_{TX}′ and θ_{TY}′ relative to the horizon in X-axis and Y-axis, respectively, are redefined as follows:

θ_{TX}′=θₓ·cosθ_{z}+θ_{y}·sinθ_{z}+θ_{Δx} (14),

and

θ_{TY}′=θₓ·sinθ_{z}+θ_{y}·cosθ_{z}+θ_{Δy} (15).

In other words, the angles θₓ′ and θ_{y}′ in the formulae (7) and (8) are replaced with the calibrated angles θ_{TX}′ and θ_{TY}′ to realize motion accelerations a_{TX}″ and a_{TY}″.

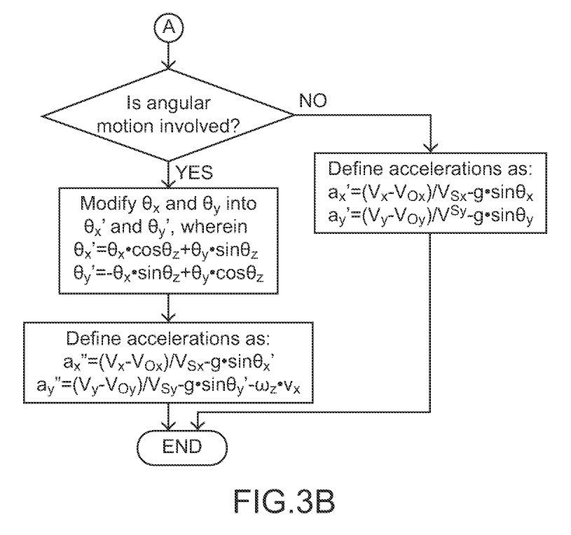

The acceleration-calibrating method described above is summarized in the flowcharts of FIG. 3A and FIG. 3B.

In the above embodiments, the motion-sensing function of the mouse device is performed by two independent uni-axial sensing units. Alternatively, the motion-sensing function of the mouse device may be performed by a single bi-axial sensing unit with two degrees of freedom.

It is understood from the above descriptions that an inertial mouse device according to the present invention desirably performs calibration of accelerations to overcome the inherent limitations including a tilting supporting plane where the mouse device is rested, non-parallel installation of accelerometers on a circuit board of the mouse device, and centrifugal force accompanying manipulation of the mouse device so as to perform precise cursor control.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A calibrating method of an inertial mouse device, comprising steps of:
discriminating whether the inertial mouse device is in a still state;
calculating a tilting angle θ of the inertial mouse device relative to horizon according to an output of an accelerometer of the inertial mouse device when the inertial mouse device is in the still state;
calculating an acceleration according to the output of an accelerometer of the inertial mouse device and the titling angle θ when the inertial mouse device is in a motional state; and
subtracting a value of g·sinθ, where g is gravity acceleration, from the calculated acceleration, thereby obtaining a calibrated acceleration.

2. The calibrating method according to claim 1 wherein the tilting angle θ indicates an angle of a bottom face of the inertial mouse device relative to horizon.

3. The calibrating method according to claim 1 wherein the tilting angle θ indicates an angle of the accelerometer relative to horizon, which equals to an angle of the accelerometer relative to a bottom face of the inertial mouse device plus an angle of the bottom face relative to horizon.

4. A calibrating method of an inertial mouse device, comprising steps of:
discriminating whether the inertial mouse device is in a still state;
calculating tilting angles θₓ and θ_{y} of the inertial mouse device relative to horizon in perpendicular X-axis and Y-axis according to calibration outputs of an accelerometer unit which performs a motion-sensing function of the inertial mouse device with two degrees of freedom when the inertial mouse device is in the still state;
calculating accelerations aₓ and a_{y} in an X-axis direction and a Y-axis direction according to the calibration outputs of the accelerometer unit and the tilting angles θₓ and θ_{y}; and
subtracting values of g·sinθₓ and g·sinθ_{y}, where g is gravity acceleration, from the calculated accelerations aₓ and a_{y}, respectively, thereby obtaining calibrated accelerations in the X-axis direction and the Y-axis direction.

5. The calibrating method according to claim 4 wherein each of the tilting angles θₓ and θ_{y} includes a component of a rotation angle θ_{z} about Z-axis perpendicular to both X-axis and Y-axis.

6. The calibrating method according to claim 5 wherein the rotation angle θ_{z} is determined by integrating an angular velocity ω_{z} of the inertial mouse device about Z-axis with time, and the angular velocity ω_{z} is realized according an output of a gyroscope of the inertial mouse device.

7. The calibrating method according to claim 4 further comprising a step of further subtracting a value of ω_{z}·vₓ, where ω_{z} is an angular velocity about Z-axis and vₓ is a velocity of the mouse device in the X-axis direction, from the calculated acceleration a_{y}, so as to obtain the calibrated acceleration in the Y-axis direction.

8. The calibrating method according to claim 7 wherein the angular velocity ω_{z} is realized according an output of a gyroscope of the inertial mouse device, and the velocity vₓ is realized by integrating the acceleration aₓ with time.

9. The calibrating method according to claim 4 wherein the tilting angles θₓ and θ_{y} indicate angles of a bottom face of the inertial mouse device relative to horizon in X-axis and Y-axis.

10. The calibrating method according to claim 4 wherein the tilting angles θₓ and θ_{y} indicate angles of the accelerometer unit relative to horizon in X-axis and Y-axis, each of which is equal to an angle of the accelerometer unit relative to a bottom face of the inertial mouse device plus an angle of the bottom face relative to horizon in X-axis or Y-axis.

11. The calibrating method according to claim 4 wherein the step of discriminating whether the inertial mouse device is in the still state includes sub-steps of:
sampling outputs of the accelerometer unit in the X-axis direction and the Y-axis direction at intervals;
monitoring the sampled outputs in a first predetermined number of sampling cycles;
comparing velocities in the X-axis direction and the Y-axis direction in last sampling cycle with a threshold if each of the sampled outputs in each axis direction lies within a specified range in the first predetermined number of sampling cycles;
determining the inertial mouse device is in the still state if each of the velocities in each axis direction is less than the threshold;
determining the inertial mouse device is in a motional state if each of the velocities in each axis direction is greater than the threshold; and
performing a further discriminating step if the velocity in one axis direction is less than the threshold and the velocity in the other axis direction is greater than the threshold.

12. The calibrating method according to claim 11 wherein the further discriminating step includes:
monitoring the sampled outputs in a second predetermined number of sampling cycles, wherein the second predetermined number is greater than the first predetermined number; and
determining the inertial mouse device is in the still state if each of the sampled outputs in each axis direction lies within a specified range in the second predetermined number of sampling cycles.

13. An inertial mouse device, comprising:
a main body;
an accelerometer unit disposed in the main body for performing a motion-sensing function of the main body with at least two degrees of freedom, and outputting a calibration output value when the main body is in a still state; and
a microprocessor in communication with the accelerometer, receiving and processing the calibration output value with an operation so as to obtain an angle of the accelerometer unit relative to horizon, generating a shift signal when the main body is in a motional state, and performing calibration for the shift signal according to the angle.

14. The inertial mouse device according to claim 13 wherein the accelerometer unit includes a first accelerometer and a second accelerometer sensing motions of the main body in a first axis and a second axis perpendicular to each other, and outputting a first calibration output value and a second calibration output value, respectively, when the main body is in the still state.

15. The inertial mouse device according to claim 14 wherein the microprocessor processes the first calibration output value with a first operation so as to obtain a first angle relative to horizon, and processes the second calibration output value with a second operation so as to obtain a second angle relative to horizon, wherein the first angle and the second angle are components of the angle in the first axis and the second axis, respectively.

16. The inertial mouse device according to claim 15 further comprising a gyroscope in communication with the microprocessor for detecting an angular motion of the main body about a third axis, and outputting a rotation calibration output value for further calibrating the shift signal.

17. The inertial mouse device according to claim 16 further comprising a circuit board disposed thereon the accelerometer unit and the gyroscope, and the first axis, the second axis and the third axis are perpendicular to one another.

18. The inertial mouse device according to claim 17 wherein the first axis is an axis penetrating front and rear of the main body, the second axis is an axis penetrating left and right of the main body and the third axis is an axis penetrating top and bottom of the main body.

19. The inertial mouse device according to claim 16 wherein the accelerometer unit includes a first accelerometer and a second accelerometer; the first calibration output value, the second calibration output value and the rotation calibration output value are voltage values, and the inertial mouse device further comprises a first analog-to-digital converter disposed between the first accelerometer and the microprocessor, a second analog-to-digital converter disposed between the second accelerometer and the microprocessor, and a third analog-to-digital converter disposed between the gyroscope and the microprocessor for converting the voltage values into digital signals.

20. The inertial mouse device according to claim 13 further comprising a circuit board disposed thereon the accelerometer unit, and a transmission interface for transmitting there via the shift signal to a computer system for cursor control.
